(19) United States
(12) Patent Application Publication
(10) Pub. No.: US 2026/0000006 A1
(43) Pub. Date: Jan. 1, 2026

(54) PTO/hydraulics coupling device.

(71) Applicant: Mark Duffy, Co. Monaghan (IE)

(72) Inventor: Mark Duffy, Co. Monaghan (IE)

(21) Appl. No.: 19/251,339

(22) Filed: Jun. 26, 2025

(30) Foreign Application Priority Data
Jun. 28, 2024 (EP) 24185516.2

(51) Int. Cl. A01B 71/06

(52) U.S. Cl. CPC A01B 71/066

(57) ABSTRACT

The coupling device is provided for connecting an implements PTO and hydraulic/electronic connections to the tractors supply source which includes a base frame substructure, with parallel mounting plates, a four-point linkage lifting frame, four linkage arms, a hydraulic/electronic connector bank, with mounting plate, two hydraulic piggy-back solution cylinder units, two piggyback hydraulic cylinder mounting plates, coupling unit, with a telescopic box section, with transfer shaft, a jaw coupler, and holding stand plate, PTO spring loaded coupling hub, a securing sleeve, compression spring, and a jaw coupler, foldable resting stand unit, with resting stand plate, two clamping plates, two tyre bumper guards, two jack leg side plate, and ground plate, an inseparable three stage PTO drive shaft, two universal joints, two profiled tubes, one profiled shaft. Thus, the base frame substructure is secured to the tractors back-end centre housing without altering any existing features, the coupling unit is a free floating device that transfers from tractor to implement by the four point lifting frame, this coupling unit device connects the implements hydraulic/electronic connections to the tractors supply, a three stage inseparable drive shaft is connected from the coupling unit to the implements rotary appliance that provides maximum length in the area where space is constrained, when the coupling unit is not is operation it is rested upon the foldable resting stand unit which is universally mounted to an implements drawbar, attached is a retractable hydraulic jack leg that elevates the implements drawbar to a set ground height, this device thereby saves the operator time and energy along with eliminating PTO hazards and accommodating paralysed operators with no requirement to dismount from the tractors seat. Also avoiding hinderance of tractors preexisting 3-point linkage, meaning the operator can simultaneously use a 3-point linkage implement while the coupling units lifting frame is still attached to the tractors back-end centre housing.

### INTRODUCTION

This Invention relates to connecting tractor implements, hydraulics/electronics and PTO (power take off), in particular trailed based implements with a draw bar.

### BACKGROUND

A tractors power take off is a common feature among agricultural tractors, used to transfer rotary power to implements which requires a power shaft.

Along with this, these implements have hydraulically/electronically operated components that require, hydraulic/electronic supply from the tractor.

These implements are often interchanged to and from the tractor, because of this it is desirable to have a coupling device that has a quick and easy removal feature for the implement.

With the use of a PTO drive shaft and hydraulic/electronic connections to connect the implement, the operator suffers several disadvantages.

For example, with the drive shaft and hydraulic/electronics it results in leaving the cab of the tractor, to connect and disconnect from tractor to implement.

It can also be very time consuming and a difficult task to carry out.

PTO Entanglement is a cause of major concern. Many machine operators have been killed and seriously injured as a result of PTO entanglement.

In order to overcome the problems associated with coupling implements, an automatic coupling device is needed for an implement to be quickly and easily connected and disconnected with a tractor.

Typically, a PTO coupling device is needed to eliminate PTO hazards with implements.

The objective of the invention is to overcome these problems prior listed.

### SUMMARY OF INVENTION

According to the aspect of the present disclosure, a coupling device is provided for connecting an implement to a tractors PTO shaft and hydraulic/electronic source.

The coupling device includes a lifting frame substructure, a four-point linkage lifting frame, two hydraulic piggy-back solution cylinder units, two hydraulic cylinder mounting plates, a PTO spring loaded coupling hub, a hydraulic/electronics fitting connector bank, a coupling unit, foldable hydraulic coupling unit resting stand, a hydraulic jackleg and inseparable three stage PTO drive shaft.

The lifting frame is attached to a tractors back-end centre housing. The two piggyback hydraulic lifting cylinders are attached to mounting plates that are also adapted to suit the tractors back-end centre housing.

The coupling unit is a universal unit that is free floating transferring from tractor to implement, using the lifting frame and coupling unit stand when connecting and disconnecting.

The hydraulic folding coupling unit stand is universally bolted to the implements draw bar. The hydraulic jack leg is also bolted to the coupling unit stand frame. The spring-loaded coupling hub is secured to the tractors power take off (PTO) shaft.

The inseparable three stage drive shaft is connected from the implement's rotary appliance to the coupling unit.

When connecting the implement, from the cab the lifting frame is unlatched and lowered by the piggyback solution hydraulic cylinders. The tractor is then reversed guiding the lifting frames hooks into position to receive the coupling unit. At this stage by lifting the lifting frame, it will hook onto the coupling unit removing it from the coupling unit holding stand.

Raising the lifting frame along with the coupling unit, it will then extend the inseparable PTO shaft. Then seating the lifting frame back to its resting position is where the linkage arms meet adjusted stoppers. From here the tractors pick up hitch is lowered to pick up the implements draw bar, pursuing to lock the hitch with the implement attached.

The hydraulics/electronics fittings connector bank is then linked with the coupling unit. Oil and electrical power can now be sent to the implement. Then in sequence, oil is sent to the PTO jaw coupler cylinders sending it forward to mesh with the PTO spring loaded coupling hub, and to the coupling unit stand retracting it, and to the hydraulic jack leg raising it.

At this point the implements draw bar has been hooked up, the PTO drive shaft has been coupled, and the hydraulic/electronic supplies have been linked.

When disconnecting the implement, in sequence the jackleg is lowered, the coupling unit stand is raised, and the coupling unit PTO jaw coupler is retracted from the spring-loaded coupling hub. Now the hydraulic/electronics fittings connecter bank is retracted, disconnecting the hydraulics/electronics from the tractor.

The tractors pick up hitch is then lowered, and the draw bar is dropped off resting on the hydraulic jackleg. Now the lifting frame is unlatched, while reversing the tractor, the lifting frame is then lowered. The inseparable PTO shaft is retracted, so that now the coupling unit can be dropped off and rested on the coupling unit stand, which is at a set height by the jackleg.

Once the coupling unit has been rested on the coupling units stand, the tractor can then pull forward, retracting the lifting frame into its resting position. From this, the implement has been unattached and the PTO drive shaft is disconnected along with the hydraulics/electronics.

With this coupling device, the operators leave the coupling unit along with the implement and can resume to using common implements with the pickup hitch and 3-point linkage.

The inventions method of design comprises of a bolt on draw bar resting stand frame, a coupling unit and the tailor-made bolt on substructure four point lifting frame that attaches to a tractors centre back-end housing, without disturbing or altering any existing features of the tractor or implement.

### BRIEF DESCRIPTION OF DRAWINGS

The invention will now be described by way of which one with reference to the accompanying drawings in which:

FIG. 1 Is an isometric view of the tractor and implements draw bar with the coupling device assembly applied and connected.

FIG. 2 Is an enlarged perspective view from the coupling units locking device of FIG. 1.

FIG. 3 Is a side view of the coupling unit disconnected from the four-point lifting frame and also the implement separated from the tractor.

FIG. 4 This is an enlarged view of the coupling unit resting on the coupling unit stand, using the stub catch plate, along with the adjustable angle adjustors, from FIG. 3.

FIG. 5 This is a side view of the coupling device connected and the tractor and implement attached.

FIG. 6 This is a plan view from above of the four-point lifting frame along with the hydraulic/electronic connector bank.

FIG. 7 Is a perspective view from above and one side of the hydraulic/electronic fittings connector bank.

FIG. 8 Is perspective view from above and one side of the lifting frame substructure and four-point lifting frame assembly with lowered hooks.

FIG. 9 Is a side elevation view of the four-point lifting frame in its retracted resting position.

FIG. 10 Is an enlarged perspective view from the side of the adjustable stoppers on the four-point lifting frame linkages from FIG. 9.

FIG. 11 Is a perspective view from above and one side of the four-point lifting frame and substructure assembly in its retracted resting position.

FIG. 12 Is an enlarged perspective view from above and one side showing the latching system of the four-point lifting frame from FIG. 11.

FIG. 13 Is an enlarged perspective view from above and one side showing the coupling units locking hook from FIG. 11.

FIG. 14 Is a sectional perspective view of the four-point lifting frames and substructure assembly.

FIG. 15 Is a front elevation view showing the four-point lifting frame in its upright retracted resting position.

FIG. 16 Is an exploded perspective view of the PTO coupling unit assembly.

FIG. 17 Is perspective view from above on one side of the coupling unit.

FIG. 18 Is side elevation view of the coupling unit with the PTO jaw coupler telescopically extended, in its engaged position.

FIG. 19 Is exploded side elevation view of the coupling unit resting pin and circular catching plate that rests the coupling unit on the coupling unit stand.

FIG. 20 Is front elevation of the coupling unit showing the attachment lifting points that the four-point lifting frame links to.

FIG. 21 Is back elevation of the coupling unit showing the circular catch plate, the PTO transfer shaft and the carrier bearing.

FIG. 22 Is a sectional perspective view of the coupling unit showing the carrier bearing and PTO transfer shaft assembly, with the coupling units jaw couplers meshed and the hydraulic/electronic connections linked.

FIG. 23 Is an exploded sectional view of the transfer PTO drive shaft bored out centre hole and the tractors PTO shaft inserted in the transfer shafts centre bore, from FIG. 22.

FIG. 24 Is a side elevation of the tailor-made bolt on draw bar mounted frame with the coupling unit resting stand raised and hydraulic jack leg lowered.

FIG. 25 Is a side elevation view of the tailor-made bolt on draw bar mounted frame with coupling unit stand retracted and hydraulic jack leg raised.

FIG. 26 Is a perspective view from above on one side of the tailor-made bolt on draw bar mounted frame attached to an implement's draw bar.

FIG. 27 And enlarged perspective view from above on one side of the coupling unit resting stands angle adjustors, shown in FIG. 26.

FIG. 28 Is perspective you from below and one side of the tailor-made bolt on draw bar mounted frame assembly.

FIG. 29 Is front elevation view of the tailor-made bolt on draw bar mounted frame demonstrating the coupling unit stand raised and hydraulic jack leg lowered, also showing the tyre bumper protection guards.

FIG. 30 Is an exploded section view of the coupling unit resting stand showing the coupling units resting stand plate, cut out U slot and tapered guided track along with levelling coupling unit brackets, from FIG. 29.

FIG. 31 Is a front elevation view of the spring-loaded coupling hub Jaw coupler.

FIG. 32 Is a perspective view from above and one side of the spring-loaded coupling hub assembly.

FIG. 33 Is side elevation view of the spring-loaded coupling hub.

FIG. 34 Is a side elevation of the inseparable three stage PTO drive shaft.

FIG. 35 Is a sectional perspective view of the inseparable three stage PTO drive shaft fully extended, showing the 3 Interlinked inseparable profiled tubes and shaft.

FIG. 36 Is an exploded sectional view of the exterior profile tube and centre tube profile demonstrating the inseparable design, from FIG. 35.

FIG. 37 Is an exploded section view of the centre profile tube on the smallest inner spined shaft, demonstrating the inseparable design, from FIG. 35.

FIG. 38 Is a perspective view from above and one side of the inseparable three stage PTO drive shaft.

FIG. 39 Is a side elevation of the inseparable three stage PTO drive shaft, showing the three profiled tubes stepped in size and portraying the spinal profiles.

FIG. 40 Is a side elevation of an alternative swivel design for the coupling unit resting stand fixed to the implement's drawbar.

FIG. 41 This is a plan view from above of the alternative swivel design for the resting stand fixed to the implement's drawbar.

FIG. 42 This is a plan view from above of the alternative swivel design for the resting stand rotated and meeting with stopper stubs.

FIG. 43 Is a perspective view from above and one side of the alternative swivel design for the resting stand rotated and meeting with stopper stubs.

FIG. 44 Is a perspective view from above and one side of the alternative swivel design for the resting stand assembly attracted to the implement's drawbar.

### DETAILED DESCRIPTION OF THE INVENTION

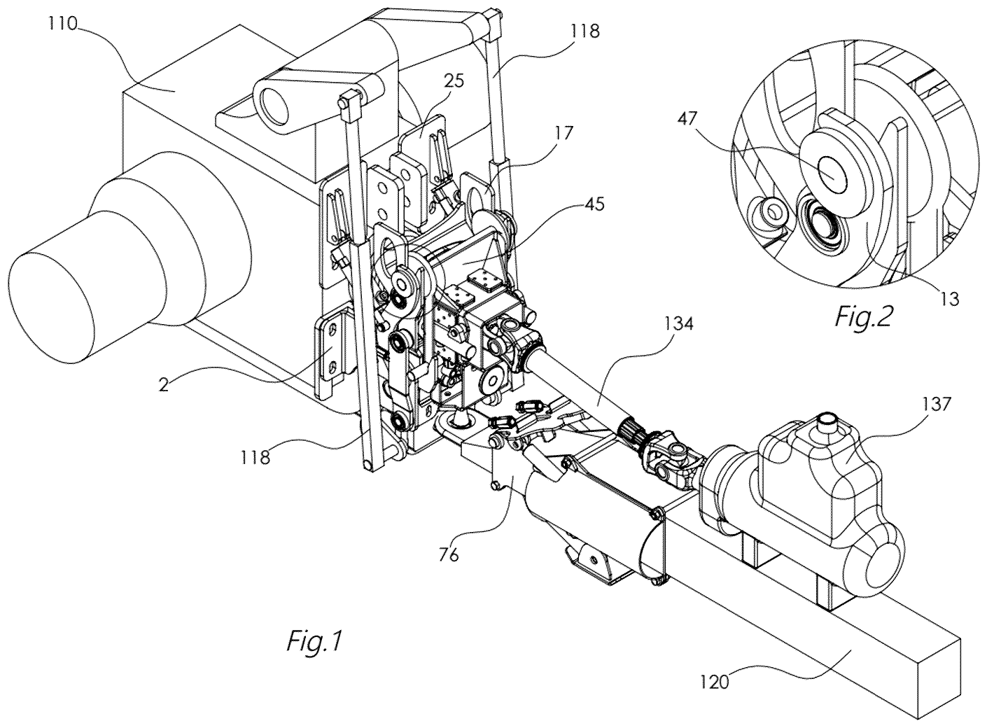

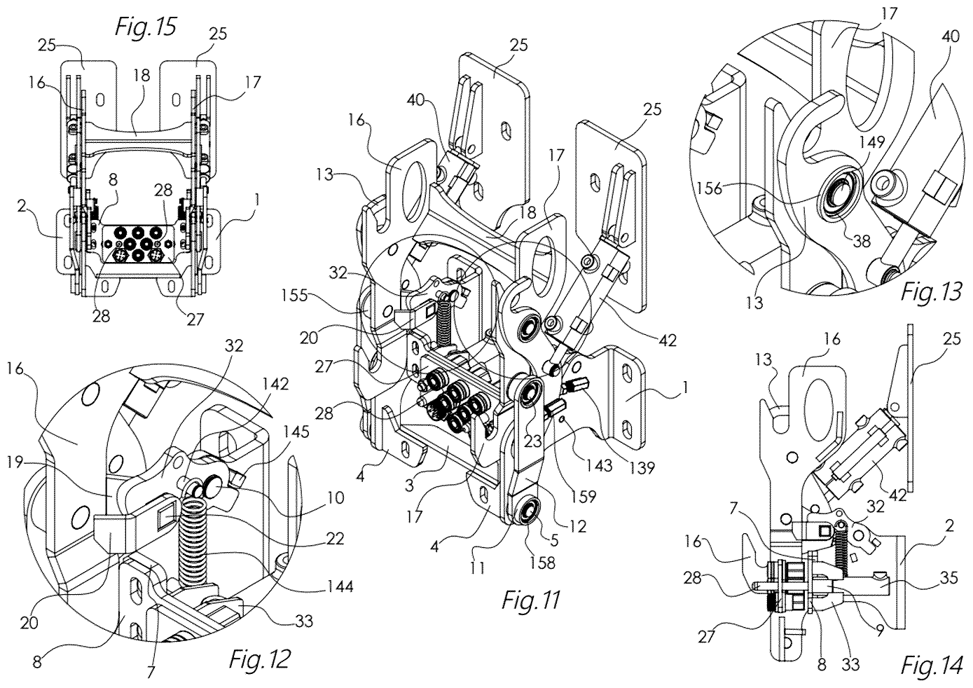

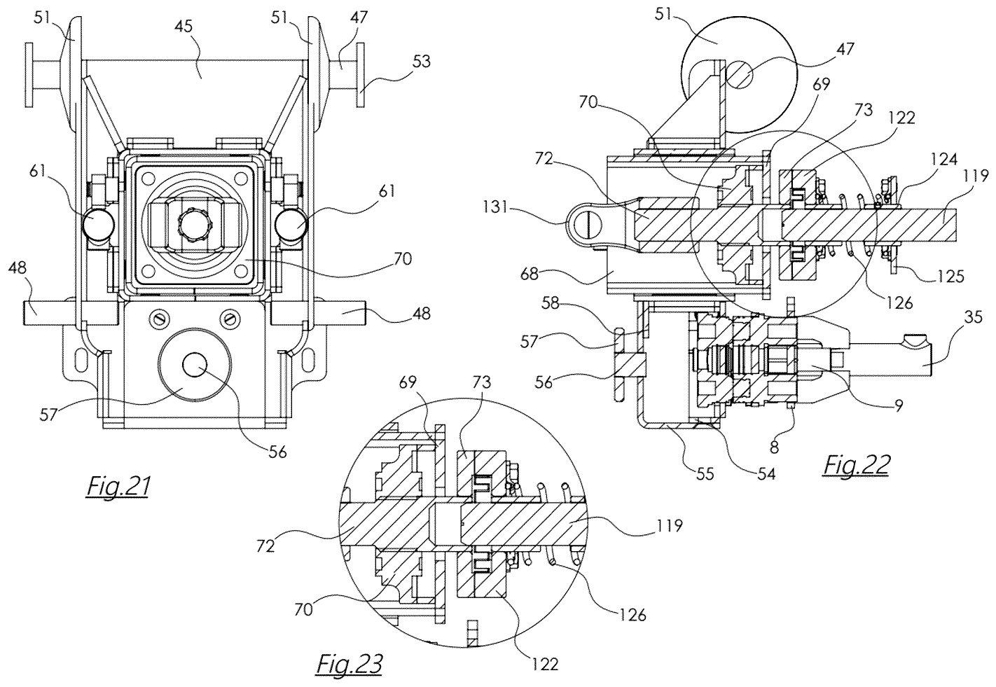

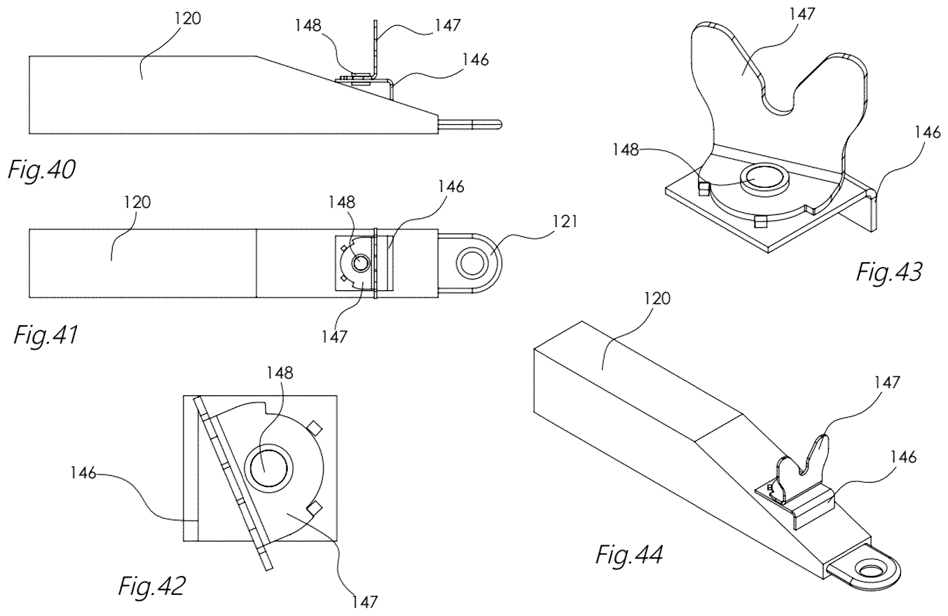

Referring to FIGS. 1 to 44, a tractors centre back-end housing 110, which supports a lifting frame substructure FIG. 8, that is secured to the back-end centre housing 110 by four bolt holes slotted for height adjustment in parallel mounting plates 1 and 2. These two components are joint together by cross member plates 3 and 4, also with slotted bolt holes for height adjustment, that make up one singular substructure, best seen in FIG. 11,

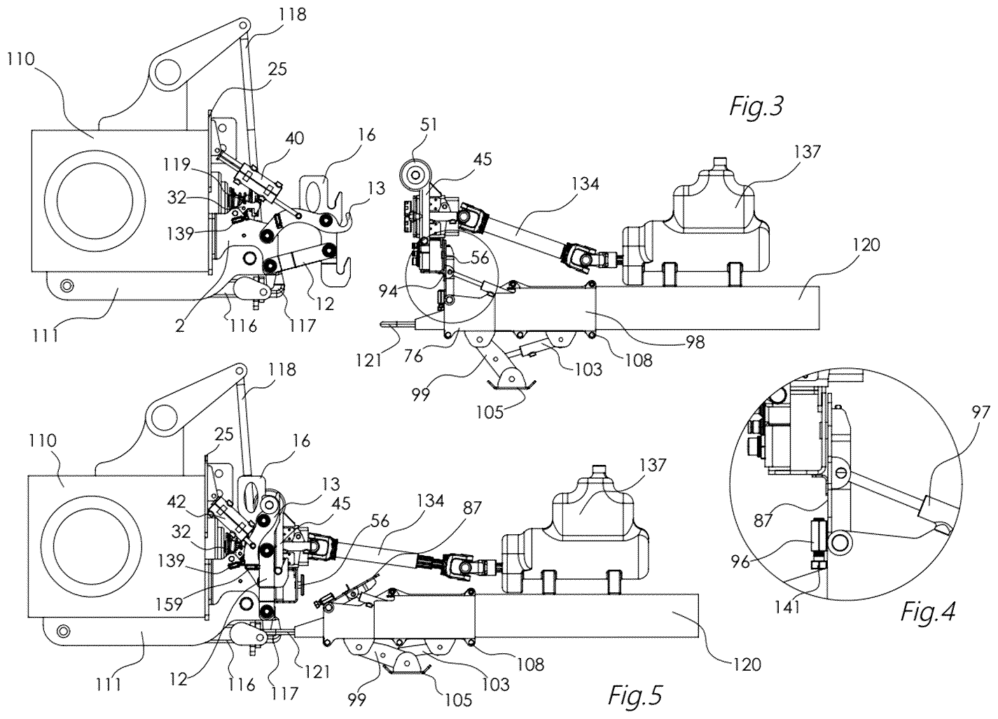

The lifting frame substructure has four linkage arms 12 and 13 attached to its parallel mounting plates 1 and 2, these pivot on fixed pins 5 and 6 swivelling on bearings 158, held on by a circlip. These linkage arms 12 and 13 link the substructure mounting plates 1 and 2 to the four-point lifting frame hook plates 16 and 17, by fixed pins 23 and 149, swivelling on bearings 38. The lifting frame is a four-point linkage made up of two vertical hook plates 16 and 17, with four hook profiles and are attached by a stability cross member 18, this lifting frame is used to retrieve and drop off the coupling unit FIG. 17, best seen in FIG. 3.

Two hydraulic cylinder mounting plates 25, with slotted holes for height adjustment, along with cylinder bolting plates 26, are secured to the tractors back-end centre housing 110. They are located above the lifting frame substructure 1 and 2, which holds two twin piggyback solution hydraulic lifting cylinders 40 and 42. Which are connected to linkage arms 13, the cylinders are used to lower and lift the lifting frame seen in FIG. 8 and FIG. 11.

When the lifting frame 16 and 17 is lowered, the tractor is then reversed and the lifting frame is aligned with the coupling unit, in FIG. 17. The lifting frames four hooking points on hook plates 16 and 17 makes contact with the coupling units lifting bar 47 and lower lifting pins 48. From here the lifting frame is lifted and tapered guide plates 51 slide the coupling unit FIG. 17 into place, lifting the coupling unit up of its resting stand plate 87.

The coupling unit stand plate 87 is where the coupling unit FIG. 17 rests when in its idle position, seen in FIG. 3. Stand plate 87 has a tapered profile V cut out leading into a U slotted hole FIG. 30. When un-attaching the coupling unit FIG. 17, the coupling unit resting pin 56 and circular catching plate 57 is guided into resting stand plate 87, by the tapered track seen in FIG. 4. The catching plate 57 prevents the coupling unit FIG. 17 sliding off its resting stand 87, a space is left between holding stand plate 55 and catching plate 57 so that the coupling unit resting pin 56 can slot easily into resting stand plate 87. Holding stand plate 55 is bolted onto structural bottom frame plate 54 and mounting plate 58 for easy access to the receiving hydraulic/electronic power connector fittings 65 and 66.

Two 90-degree levelling brackets 94 and 95 are attached to resting stand plate 87. Holding stand plate 55 resting upon these plates and their purpose is to level the coupling unit FIG. 17 when the resting pin 56 is rested on stand plate 87, seen in FIG. 3. Two threaded adjuster long nuts 96, are fixed to resting stand plate 87 with threaded adjuster bolts 141, that meet the implements draw bar 120. These adjusters bolts 141 are used to set the angle of resting stand plate 87 for the coupling unit, when attaching and detaching the coupling unit FIG. 17. This is best illustrated in FIGS. 26 and 27.

An alternative design for the resting stand can be seen in FIG. 44. This design consists of a swivelling stand with a tapered V profile cut out leading into a U-shaped slotted hole resting stand plate 147 that rotates to meet stoppers on folded base plate 146 seen in FIG. 42, either left or right depending on the angle of attaching or detaching of the coupling unit, FIG. 17. This plate pivots on a pin 148, that is welded to the folded base plate 146, which is fixed to the implement's drawbar 120.

As the lifting frame is lifted, the inseparable PTO drive shaft FIG. 38 extends, this shaft consists of two universal joints and three stage profiled tubes FIG. 39. The PTO drive shaft yoke end 131 is connected to the implements PTO rotary appliance 137, also attached is a universal cross 132 and yoke end 138. The smallest profile tube 136 is connected to yoke end 138 and fixed by a roll pin 115.

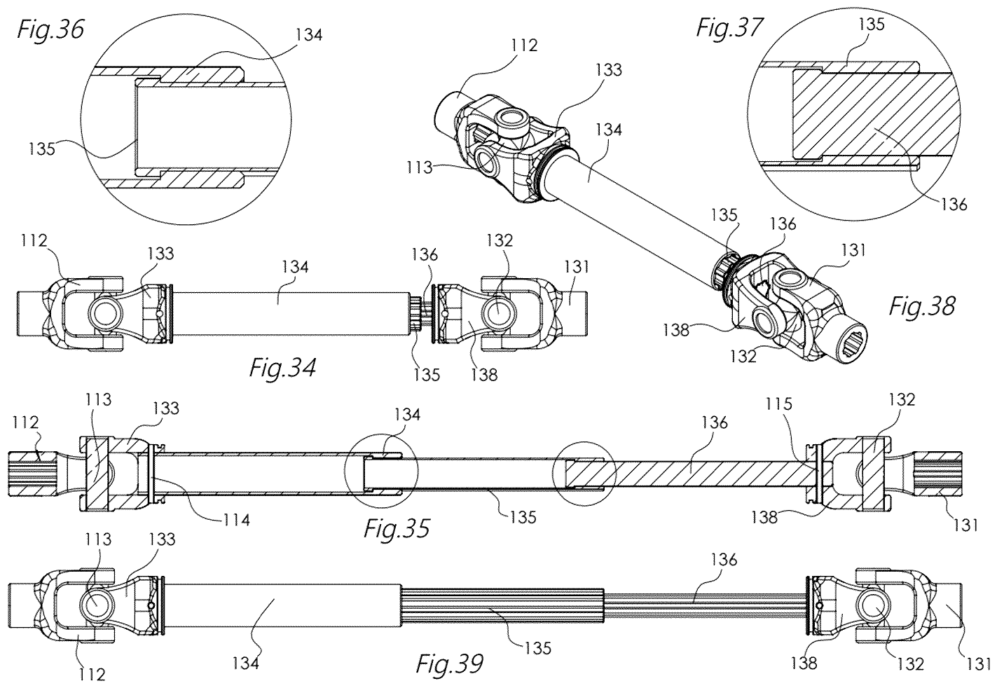

At the coupling unit FIG. 17, it has a carrier bearing 70, which holds a transfer shaft 72 best seen in FIG. 22. Connected to this transfer shaft 72 is the opposite side to the inseparable PTO shaft FIG. 34, by another yoke end 112 attach to this is a universal cross 113 and yoke end 133, that is fitted to the profile shaft 134 fixed by another role pin 114.

The smallest inner profile shaft 136 and largest outer profile tube 134 are linked by a third middle profile tube 135. When the PTO shaft is being lengthened, inner profile shaft 136 which has splines on the outer surface only, FIG. 39, slides within the middle profile tube 135 which has a short inner receiving splines shoulder seen in FIG. 37, these splines mesh inner profile tubes 136 outer surface splines, to the middle profile tubes 135 inner splines FIG. 37. Inner profile shaft 136, has a machined shoulder end that makes contacts with middle profiled tube 135 end stepped inner splines, so that when lengthening the shaft it stops middle profiled tube 135 and inner profiled shaft 136 coming apart FIG. 37.

On the other end of the inseparable PTO drive shaft, the outer profiled tube 134 Is attached to yoke end 133. Outer profiled shaft 134 is connected to middle profiled tube 135, as the PTO shaft is lengthened, middle profile tube 135 slides within outer profile tube 134 until its stepped shoulder meets outer profiled tube 134 inner splines shoulder, seen in FIG. 36. This stopping outer profiled tube 134 and middle profiled tube 135 coming apart, FIG. 36.

The outer profiled tube 134 and middle profiled tube 135, are meshed by splines on middle profiled tube 135 outer surface and the inner stepped surface of outer profiled tube 134. Note that the inner surface of both outer profiled tube 134 and middle profiled tube 135 have not got splines the full length of inside the tubes, to allow for the machined shoulder to catch the end of the small section of spline, to prevent the shaft coming apart.

This design is to provide maximum length in the area where space is constrained, FIG. 5. It also prevents the separation of the drive shaft when the coupling unit FIG. 17 is attached to the lifting frame, FIG. 11. At the stage when the lifting frame is in its seating position and before the implements drawbar 120 hook eye 121 is attached to the tractors pick up hitch hook 117, best seen in FIG. 5.

At this stage the coupling unit FIG. 17, is attached to the four-point linkage lifting frame FIG. 8. As it continues to retract, lifting hook plates 16 and 17 have a stepped folded and formed section so that when the lifting frame is in its seated position FIG. 11, lifting hook plates 16 and 17 will slot in to clear the substructure without collision of, parallel mounting plates 1 and 2.

While the lifting frame is being retracted, latching hooks 32 that swivel on hook hinge pins 10 fixed to the base frames mounting plates 1 and 2. The latching hooks 32 that are held under tension by torsion springs 144, based on a hook spring pin 142 and base spring pin 143. Latch stoppers 145 hold the latch hooks at the correct angle, FIG. 12. The latching hooks 32 are pressed against by a latching bar 22 fixed to the lifting hook plates 16 and 17, secured by latching brackets 19 and 20.

Latching bar 22 passes under the latching hook 32 locking it in place, FIG. 12. These latching systems are located on either side of the lifting frame substructure parallel mounting plates 1 and 2.

When unlatching to release the lifting hook plates, latching hooks 32 are lifted allowing the latching bar 22 to clear from under the latching hooks 32, freeing lifting hook plates 16 and 17.

When the lifting frame has been retracted fully FIG. 11, linkage arms 13 has closed its profiled locking hooks FIG. 13 on the coupling units lifting bar 47, locking it in place from jumping out, best seen in FIG. 2, and FIG. 13. In this position linkage arms 13 is rested against threaded adjuster stopper bolts 15 and long nuts 139, that is fixed to both sides of the lifting frame substructure parallel mounting plates 1 and 2.

Linkage arms 12 is rested against thread stopper bolts 21 and long nuts 159 that is fixed to linkage arm 13, at this point the lifting hook plates 16 and 17 is fully retracted with the coupling unit hooked on, seen in FIG. 5.

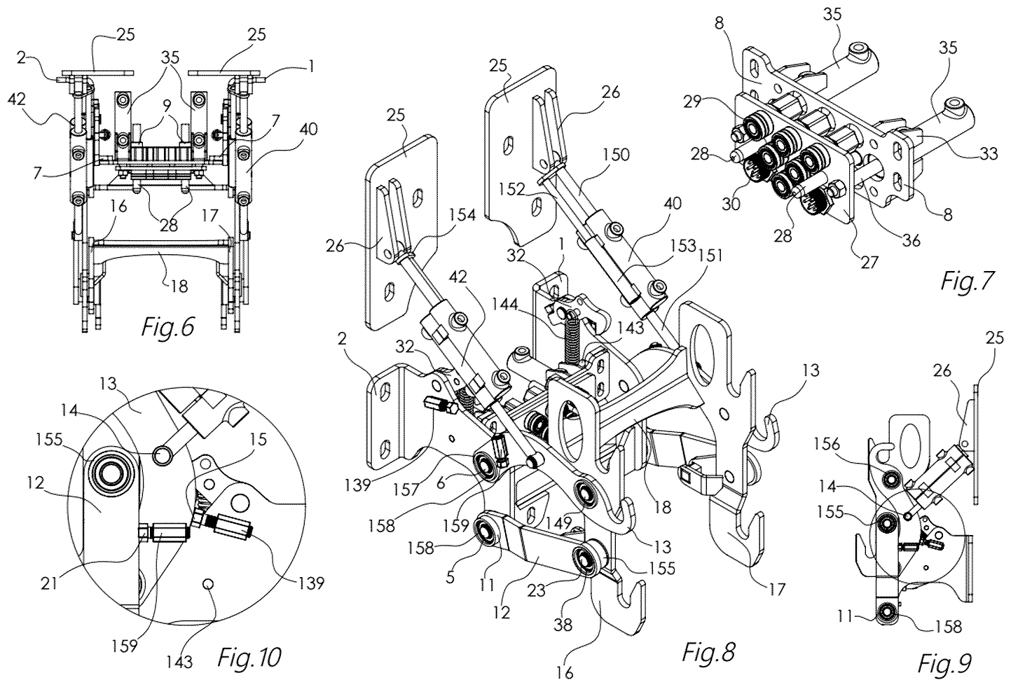

The tractors pick up hitch base 116 is then lowered to attach the implement drawbar 120. Next the implements hydraulics/electronics connectors 29 and 30, and receiving hydraulics/electronics connectors 65 and 66, are connected using the fittings connector bank, FIG. 7. The fittings connector bank assembly has a profiled connector bank mounting plate 8 that has four slotted holes for height adjustment, that when bolted in place to mounting brackets 7 fixed to parallel mounting plates 1 and 2, which sits between the parallel mounting plates 1 and 2, seen in FIG. 6. Using two double acting hydraulic cylinders 35, that are bolted to inner side of connector bank mounting plate 8, by cylinder plates 33 welded to hydraulic cylinders 35.

The hydraulic cylinder rod 36 end is threaded and bolted into fitting connector plate 27. Which push and pull the fittings connector plate 27, when connecting and disconnecting the hydraulic/electronic connectors 29 and 30, with the receiving hydraulics/electronics connectors 65 and 66. The fitting connector plate 27 uses two sliding guide rods 28, these rods slide in two bushing guide sleeves 9, that are fixed to one side of connector bank mounting plate 8, seen in FIG. 6. These guide the fittings connector plate 27 straight when connecting the hydraulic/electronic connectors 29 and 30.

Now the sliding guide rods 28 make contact with the coupling units guide bushings 52, seen in FIG. 20. These guide bushings 52 are used to align the fittings connector plate 27. Sliding guide rods 28 and guide bushings 52 make contact first before the hydraulic/electronic connectors 29 and 30, so that when the hydraulic/electronic connectors 29 and 30 are connecting, they line up correctly with the coupling units receiving hydraulic/electronic connectors 65 and 66, FIG. 22.

Once the hydraulic/electronic connectors have been connected, oil is then sent to the coupling units telescopic box section 68 hydraulic cylinders 61. These cylinders are welded to amounting bracket 62 that is based on a fixed pin 60, welded to hollow box section frame 46. The hydraulic cylinder rod 74 end is threaded and bolted to profiled face plate 69, to push and pull the jaw coupler 73 when engaging and disengaging the PTO, FIG. 18.

The carrier bearing 70 frame consists of a box section 68 and face plate 69. The carrier bearing 70 is inserted into a box section 68 with a spacer plate 71 behind it. Both are bolted to the attached face plate 69, the carrier bearing 70 supports the transfer shaft 72 with a welded on the jaw coupler 73. The box section 68 slides within hollow box section frame 46, that is fixed to the coupling units main structural frame 45 sliding on six nylon wear guides 67.

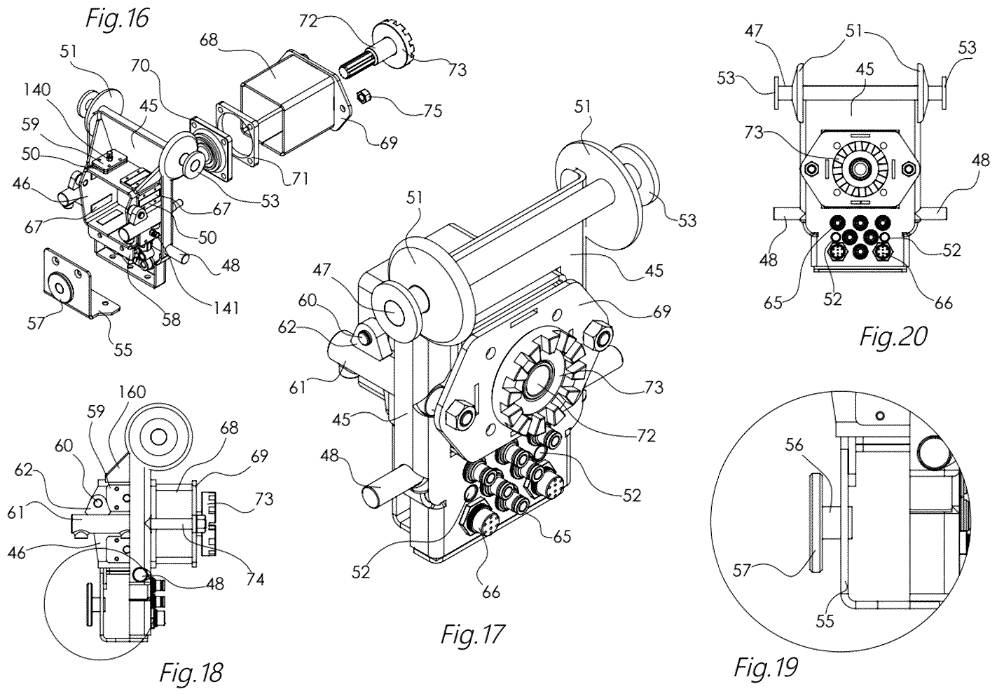

Six rectangular slotted holes on each side of box section frame 46 along with six surrounding spacer plates 50 welded to box section frame 46 for nylon wear guides 67, best seen in FIG. 16. Four threaded holes in spacer plates 50 that are located on each side of box section frame 46, on top of these is six cap plates 59 that have four outer bolt holes, FIG. 16. These are to secure it to spacer plate 50 and also to hold the six nylon wear guides 67 in place. A centre hole on cap plates 59 has an adjustable threaded nut 140 and threaded bolt 39, to tighten the nylons wear guides 67 against the box section 68 as it wears.

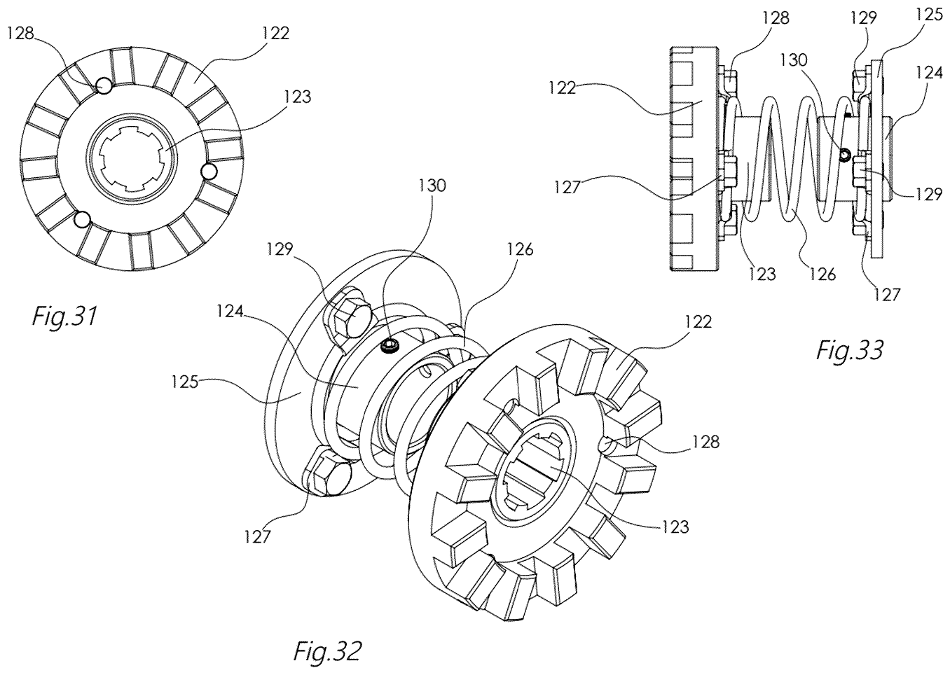

As the jaw coupler 73 is pushed forward, it then comes into contact with a receiving jaw coupler 122. This jaw coupler is a component of the spring-loaded coupling hub assembly, seen in FIG. 32. The coupling hub is attached to the tractors PTO shaft 119. The spring-loaded coupling hub has a securing sleeve 124 and circular profiled plate 125, that is secured onto the tractors PTO shaft 119.

Circular profiled plate 125 has a compression spring 126, this spring keeps jaw coupler 122 under constant compression when it is pressed by the coupling units jaw coupler 73. It makes sure the machined teeth mesh and stay meshed when the PTO is engaged, best seen in FIG. 22. Clamped to profiled plate 125 by means of three spring clamps 127, using threaded bolts 129, this spring sits over securing sleeve 124 centring the compression spring 126, FIG. 33.

The securing sleeve 124 has two grub screws 130, located 90 degrees apart to tighten the coupling hub assembly FIG. 32 to the tractors PTO shaft, 119. A jaw coupler 122 is welded to a universal six splined PTO sleeve 123, that slides onto the tractors PTO shaft 119 meshing with splined PTO sleeve 123 splines, in front of securing sleeve 124. This jaw coupler 122 is fixed to the opposite side of compression spring 126, by spring clamps 127 and threaded bolts 128, to prevent the jaw coupler 122 separating from the assembly, FIG. 33.

As the coupling units jaw coupler 73, is pushed forward it is pressed against the receiving jaw coupler 122 that compresses the compression spring 126 back. Because of this, the coupling hub FIG. 32 has a space between the 6 splined PTO sleeve 123 and the securing sleeve 124, so that when these jaw couplers meet and don't mesh first time, jaw coupler 122 can be shoved back until jaw coupler 73 and jaw couplers 122 machined teeth and grooves mesh together.

As the PTO is engaged and rotates it springs jaw coupler 122 forward meshing jaw coupler 73 and jaw couplers 122 teeth together, best seen in FIG. 22. From this the tractors PTO shaft 119 has been engaged with the implements PTO rotary appliance 137.

Now in sequence the coupling units resting stand plate 87 is retracted, FIG. 25, by two hydraulic cylinders 97 at either side of the implement's drawbar 120, based on a fixed pin 78 welded to each side clamping plate 76. With the cylinder rod 31 secured at cylinder mounting brackets 91, that are welded to coupling unit resting stand plate, 87.

These clamping plates 76 are placed one each side of the implement's drawbar 120, clamping them to the drawbar by bolts 107 and 108. The coupling unit resting stand plate 87 has a hinging pin 90 attached, that hinges in a bored hole in both side clamping plates 76. Two tyre bumper guards 86 and 98 are bolted by two bolts 107 and 108, with four bolting tabs 82, to either side of the implement's drawbar 120, onto the side clamping plates 76. These tyre bumper guards 86 and 98 are to prevent the tractors tyre striking the coupling unit stands hydraulic cylinders 97 when turning.

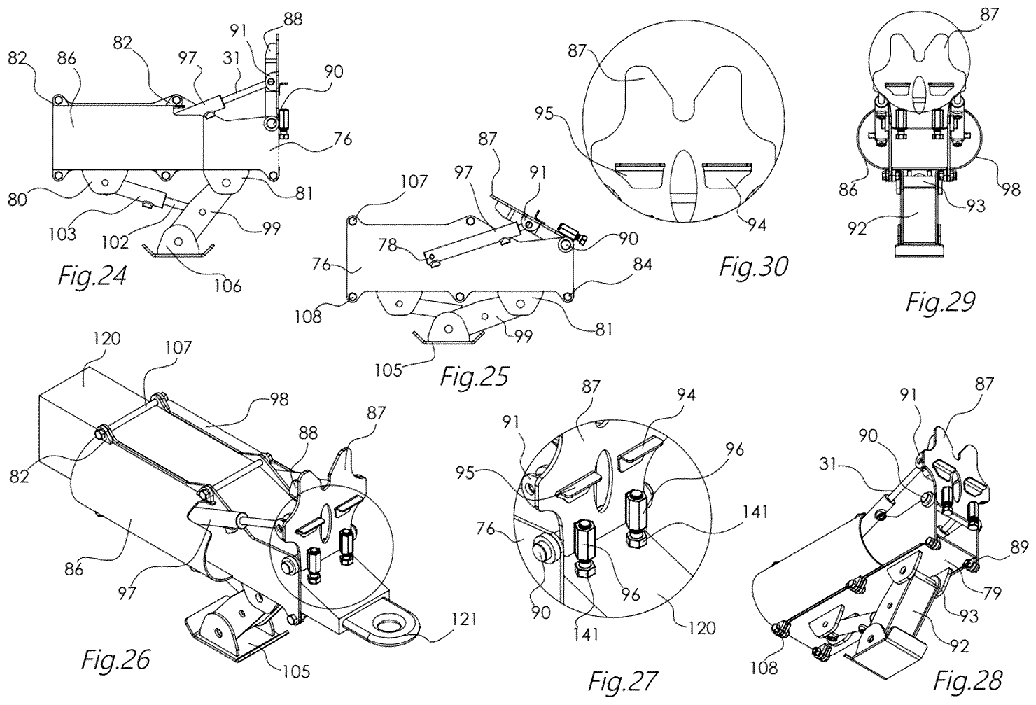

Also, at the same time the hydraulic jack leg, best seen in FIG. 24, is lifted FIG. 25, by means of a single double acting hydraulic cylinder 103 secured by pins at mounting brackets 80 and jack leg side plates 99. The jack leg is made up of two jack leg plates 99 braced together by a bracing plate 92 and a wear pivot bushing 93. Attached to the jack leg is a swivelling foot assembly made up of a folded ground plate 105 and jack foot securing plates 106 pivoting on the jack leg plates 99 that rests parallel with the grounds angle, FIG. 24. The jack leg assembly is attached to a sub assembly of jack leg mounting plates 81 and a base plate 79 that is placed on bottom of the implement's drawbar 120. The base plate 79 has six bolt tabs 89 attached that clamp the jack leg sub assembly, best seen in FIG. 28, to both side clamping plates 76 of the implement's drawbar 120.

With this universal design it allows the assembly to be clamped and bolted onto any implement with a trailed drawbar 120.

From here the hydraulic/electronic fittings have been connected, FIG. 22. The PTO shaft has been linked, FIG. 22. The jack leg has been lifted, FIG. 25 and the coupling unit stand has been retracted, FIG. 25.

At this stage the coupling unit device has been completely attached linking the hydraulic/electronic connections and PTO shaft, seen in FIG. 5 and FIG. 1.

1-8. (canceled)

9. A PTO/hydraulics coupling device, comprising:
a lifting frame substructure consisting of two parallel mounting plates which are tailored to be bolted to a tractor's back-end centre housing;
a four-point linkage lifting frame that is hinged to the lifting frame substructure by linkage arms;
two hydraulic piggy-back solution cylinder units configured to lift the four-point linkage lifting frame;
two hydraulic cylinder mounting plates configured to be bolted to the tractor's upper back-end centre housing and configured to secure the two hydraulic piggy-back solution cylinders, wherein the two hydraulic piggy-back solution cylinders are configured to raise and lower the four-point linkage lifting frame;
a PTO spring loaded coupling hub configured to be fastened to the tractor's power take off (PTO) shaft;
a hydraulic/electronic fittings connector bank bolted to the lifting frame substructure;
a coupling unit configured to transfer from the tractor to an implement and to link with the PTO spring loaded coupling hub and the hydraulic/electronic fittings connector bank, wherein the PTO spring loaded coupling hub is configured to transfer rotary power from the tractor to the coupling unit and wherein the hydraulic/electronic fittings connector bank is configured to connect hydraulic/electronic connectors to the coupling unit hydraulic/electronic connectors;
a foldable hydraulic coupling unit resting stand pivotally mounted on clamping plates, wherein the clamping plates are configured to be bolted to the implement's drawbar and wherein the foldable hydraulic coupling unit resting stand is configured to hold the coupling unit when not attached to the four-point linkage lifting frame;
a hydraulic jackleg configured to be pivotally mounted on the implement's drawbar to elevate the foldable hydraulic coupling unit resting stand to the correct height when attaching the coupling unit; and
an inseparable three stage PTO drive shaft secured at one end to a transfer shaft of the coupling unit and configured to be secured at the other end to a driven member of the implement, wherein the inseparable three stage PTO drive shaft is configured to prevent the coupling unit from being separated from the implement.

10. The PTO/hydraulics coupling device of claim 9, wherein:
the two parallel mounting plates comprise 90 degree formed folds left and right with slotted holes to allow for fine height adjustable alignment of the coupling unit's transfer shaft with the tractor's PTO shaft; and
the two parallel mounting plates are coalesced and welded together by cross member plates, wherein the cross member plates are welded to the inner side of both parallel mounting plates and have slotted holes to allow for fine height adjustment and are configured to be bolted to the tractor's hitch frame.

11. The PTO/hydraulics coupling device of claim 10, wherein the lifting frame substructure comprises:
a hydraulic/electronic connector bank mounting plate with slotted holes for fine adjustable alignment;
two mounting brackets welded on the inner side of both parallel mounting plates, wherein the hydraulic/electronic connector bank mounting plate is bolted to the two mounting brackets;
a fittings connector plate configured to hold the hydraulic/electronic connectors;
two hydraulic double acting cylinders, both bolted to the hydraulic/electronic connector bank mounting plate, and configured to push and pull the fittings connector plate;
two bushing guide pipes that are welded to the inner side of the hydraulic/electronic connector bank mounting plate;
two sliding guide rods that are welded to the fittings connector plate and are configured to slide within the two bushing guide pipes to keep the hydraulic/electronic connectors connecting with accuracy;
the linkage arms which comprise four profiled and formed linkage arms with inserted and welded bushing sleeves and are configured to pivot on four bearings to allow it to be raised and lowered, wherein the four linkage arms are secured in place by inner circlips to the welded bushing sleeves, and pivotally mounted and secured by an exterior circlip on four hinging pins aiming outwardly and welded on the inner side on both parallel mounting plates, and wherein the four linkage arms comprise first and second linkage arms and third and fourth linkage arms;
first and second long nuts that are each welded to the outer side of each of the third and fourth linkage arms with adjuster bolts, wherein the first and second long nuts are used as a stopper for each of the first and second linkage arms, wherein a profiled hook shape is incorporated into each of the third and fourth linkage arms that secures a lifting bar of the coupling unit in place;
third and fourth long nuts that are each welded to the outer side of both parallel mounting plates with adjuster bolts, wherein the third and fourth long nuts are used as a stopper for each of the third and fourth linkage arms;
hook hinge pins aiming inwardly and welded on the outer side of both parallel mounting plates;
two latching hooks, that rest against stoppers, wherein the two latching hooks are pivotally mounted and are secured in place with an exterior circlip on the hook hinge pins; and
torsion springs mounted on a hooks spring pin and on a base spring pin on both parallel mounting plates to keep tension on each of the two latching hooks when in contact with a lifting frame latching bar.

12. The PTO/hydraulics coupling device of claim 11, wherein the four-point linkage lifting frame comprises:
two four-point profiled and formed lifting hook plates that have a stepped fold at their lower end to avoid collision with the two parallel mounting plates, wherein the lifting frame substructure is the anchor for the four-point linkage lifting frame;
a stability cross member welded on the inner sides of the two lifting hook plates;
four linkage hinge pins aiming outwardly located and welded on the inner sides of the two lifting hook plates for mounting of bearings that are each secured by an exterior circlip, wherein the bearings are pivotally mounted and each secured by an inner circlip within bushing sleeves and are inserted and welded to the linkage arms;
two latching bracket plates that are welded aiming inwardly to the back of each of the two lifting hook plates, wherein each of the two latching bracket plates are configured to halter a lifting frame latching bar.

13. The PTO/hydraulics coupling device of claim 11, wherein
each of the two hydraulic piggy-back solution cylinder units comprises two hydraulic piggy-back solution cylinder barrels welded back to back in opposite directions with first and second extending cylinder rods, wherein two bushing guide sleeves are welded to the inner side of both of the two hydraulic piggy-back solution cylinder barrels, a sliding guide rod is fixed to the first extending cylinder rod by an adjoining brace plate and is configured to keep the two hydraulic piggy-back solution cylinder barrels in a parallel position with the two parallel mounting plates;
the two hydraulic cylinder mounting plates comprise two cylinder bolting plates welded on each of the two hydraulic cylinder mounting plates and configured to bolt and secure the first extending cylinder rod of each of the two hydraulic piggy-back solution cylinder units; and
the second extending cylinder rod of each of the two hydraulic piggy-back solution cylinder units is pivotally mounted and secured by an exterior circlip on a hinging pin on the outer side of each of the third and fourth linkage arms.

14. The PTO/hydraulics coupling device of claim 11, wherein the coupling unit comprises:
a structural frame that has a square profiled hole;
a formed hollow box section frame welded in the structural frame and with triangular gussets welded on the top corners of the box section frame to the structural frame;
eight rectangular holes with two on each side of the box section frame, which have inserted nylon wear guides held in place by face plates;
an adjuster nut that is welded to the centre of a face plate with an adjuster bolt to tighten the nylon wear guides, that press against a hollow telescopic box section which slides within the box section frame;
a profiled face plate welded to the outer front side of the box section;
a spacer plate and a carrier bearing haltered and bolted to the inner back side of the face plate;
two hydraulic cylinders that have mounting brackets welded to the opposite side to the hydraulic ports on each of the two hydraulic cylinders and that are pivotally mounted on a hinge pin that is inserted and welded, one each side of the box section frame;
hydraulic cylinder rods that have a thread end and are bolted to the face plate by a lock nut, which extends and retracts the box section;
a cross member lifting bar welded to the top front face of the structural frame m wherein the cross member lifting bar is fitted with slide prevention stopper washers on each outer side of the lifting bar, and fitted with tapered guide plates that are welded to and pressed against each folded side of the structural frame and are used to guide connection of the four-point linkage lifting frame;
two lower lifting pins inserted and welded in a circular profiled hole on each folded side of the structural frame;
six circular profiled holes in the bottom front face of the structural frame that are configured to halter the coupling unit hydraulic/electronic power connectors;
two guide bushings configured to align with the sliding guide rods;
a folded 90 degree holding stand plate that is bolted by counter sunk bolts to a bottom mounting plate of the structural frame and to a mounting plate which is welded to the bottom of box section frame;
a coupling unit resting pin that is inserted and secured to the outer back side of holding stand plate;
a circular catching plate welded to end of the coupling unit resting pin and configured to prevent the coupling unit from sliding off the foldable hydraulic coupling unit resting stand.

15. The PTO/hydraulics coupling device of claim 14, wherein the transfer shaft of the coupling unit is a solid shaft, with an exterior standard 6 spline PTO shaft at the implement side of the transfer shaft, where it then steps up to a larger diameter that seats within the carrier bearing, then from the carrier bearing on the transfer shaft it has a larger diameter stepped shoulder, protruding through the face plate with a jaw coupler that is welded to the end of the exterior surface on the tractor side of transfer shaft, wherein this end shaft has a short segment of machined out hollow section, for alignment of the tractor's PTO shaft with the transfer shaft.

16. The PTO/hydraulics coupling device of claim 9, wherein the PTO spring loaded coupling hub comprises:
a securing sleeve configured to be secured by grub screws to the tractor's PTO shaft;
a circular backing plate that has a centre hole and is welded to securing sleeve having an inwardly protruding shoulder to centre compression spring;
a jaw coupler;
three threaded holes in the circular backing plate with bolts configured to hold spring clamps clamped to the compression spring, wherein, on the opposite side of compression spring, it is held by spring clamps which are bolted by bolts to threaded holes in the jaw coupler, wherein the jaw coupler has a machined centre hole with a welded in 6 splined PTO sleeve which also has a protruding inwardly shoulder to centre the compression spring that is welded in the centre hole of the jaw coupler, and wherein the jaw coupler is configured to keep the PTO engaged under compression by compression spring.

17. The PTO/hydraulics coupling device of claim 14, further comprising:
a profiled hole in the clamping plates that has a pivotally hinging pin, wherein the foldable hydraulic coupling unit resting stand is welded to the tangential surface of the hinging pin, and wherein the foldable hydraulic coupling unit resting stand has a V shaped cut out leading into a U shaped slot, which is where the coupling unit resting pin is configured to rest upon when in its idle position and subsequently latches onto the circular catching plate;
two levelling brackets that are welded to the front face of the foldable hydraulic coupling unit resting stand and are configured to level the coupling unit by meeting the holding stand plate;
two long nuts and adjuster bolts configured to set the angle of the foldable hydraulic coupling unit resting stand and adjust against the implement's drawbar;
two formed strengthening plates welded to the back side of the foldable hydraulic coupling unit resting stand;
four cylinder mounting brackets welded to the outer back left and right wings of the foldable hydraulic coupling unit resting stand;
two hydraulic cylinders bolted to mounting plates and pivotally mounted on a fixed pin that is welded to both outer sides of the clamping plates which are configured to raise and lower the foldable hydraulic coupling unit resting stand;
two tyre bumper guards each with a cut out slot for the hydraulic cylinder and having four bolding tabs welded onto the tyre bumper guards and configured to be bolted by bolts on the outer sides of both of the clamping plates;
a base plate with welded on bolting tabs that are configured to be bolted by bolts to the inner side between both clamping plates on the underside of the implement's drawbar;
two jack leg mounting plates that are welded to base plate and configured to halter pivotally bolted jack leg side plates;
a bracing plate welded between jack leg side plates along with a wear pivot bushing;
a jack leg foot pivotally bolted to the bottom exterior side of the jack leg side plates and consisting of two pivot mounting plates welded to a profiled and folded ground plate;
two hydraulic cylinder mounting brackets welded to the bottom side of the base plate; and
a hydraulic cylinder pivotally bolted to the two hydraulic cylinder mounting brackets, wherein a cylinder rod of the hydraulic cylinder is secured to the jack leg side plates which raise and lower the jack leg side plates when attaching and detaching the implement's drawbar.

18. The PTO/hydraulics coupling device of claim 14, wherein the foldable hydraulic coupling unit resting stand comprises:
a folded base plate which is configured to be welded to the implement's drawbar;
a bored circular hole that has an inserted and welded centre pivot pin;
a coupling unit profiled resting plate configured to pivot on the centre pivot pin, wherein the coupling unit profiled resting plate has a V shaped cut out leading into a U slot profile, that is configured to halter the coupling unit resting pin, wherein
the coupling unit profiled resting plate is folded 90 degrees and is pivotally mounted on the centre pivot pin,
a cut out semi-circle track on the coupling unit profiled resting plate is configured to rotate to the angle that is required when attaching or detaching the coupling unit and parallel with plate until the resting coupling unit profiled plate meets stoppers located on the folded base plate.

19. The PTO/hydraulics coupling device of claim 9, wherein the inseparable three stage PTO drive shaft comprises:
a universal joint made up of a PTO 6 splined yoke end attached at two sides of a universal joint cross and connected to the remaining two opposite sides is another yoke end which has an inserted roll pin configured to secure it to a first profiled tube which has a 50 mm long stepped section of inner splines at the end of the first profiled tube;
a second smaller centre profiled tube which has exterior splined surface almost the full length of the second profiled tube and is configured to slide within and mesh with the inner splines of the first profiled tube, wherein a 12 mm thick stepped stopper shoulder is machined larger than the splined surface at one end of the second profiled tube which meets with the inner stepped splined shoulder in the first profiled tube to prevent separation of the first profiled tube and the second profiled tube, also having a 50 mm long stepped section of inner splines at the opposite end of the second profiled tube, wherein
the second profiled tube is configured to mesh and slide over and on the exterior splined surface of a profiled shaft which is a solid shaft with exterior splines almost the full length of the profiled shaft along with a 12 mm thick stepped stopper shoulder machined larger than the splined surface at one end of profiled shaft this shoulder meets with the inner stepped splined shoulder in the second profiled tube to prevent separation of the second profiled tube and the profiled shaft, secured by roll pin, the profiled shaft is inserted into yoke end attached to sides of a universal joint cross and connected to the remaining two opposite sides of the universal joint cross is a PTO 6 splined yoke end.
